(19) United States
(12) Patent Application Publication
(10) Pub. No.: US 2024/0087069 A1
(43) Pub. Date: Mar. 14, 2024

(54) METHOD-MODEL FOR SUSTAINABLE LEADERSHIP DEVELOPMENT

(71) Applicants: Judy Carr, Columbia, SC (US); Kenneth-Maxwell Nance, Gimpo (KR)

(72) Inventors: Judy Carr, Columbia, SC (US); Kenneth-Maxwell Nance, Gimpo (KR)

(21) Appl. No.: 17/823,946

(22) Filed: Aug. 31, 2022

(51) Int. Cl. G06Q 50/20; G06Q 10/06

(52) U.S. Cl. CPC G06Q 50/2057; G06Q 10/067

(57) ABSTRACT

A method and model for sustainable leadership development, premised on the sustainable-unsustainable leadership theory (SULT) is set forth herein to intervene in the phenomenon of leadership failure and associated crises. Empirical evidence of leadership failure longitudinally, demonstrated a need for a paradigm shift for leadership. Unnecessary war-related deaths and expenditures, scandals, and other harms to people are unsustainable. The method and model supported by leadership's grand theory, is underpinned by a 3-year exploratory sequential mixed methods study. A theory emerged during theoretical sampling and constant comparative analysis of interviews from six continents, giving rise to the aphorism “leadership in the absence of moral action is unsustainable.” Random sampling from 2,523 global cases, analyzing 2,191 in a quantitative phase, showed statistically significant association between unethical leadership action (ULA) and unsustainable leadership outcomes (ULO), χ² (1, N=2,191)=119.643, p<0.001. There was relatively strong association between the variables.

### BACKGROUND OF THE INVENTION

Leadership as commonly understood, experiences degradation, harm, and failure with

increasing risks, attributed to leadership failure; this state worsened by a lack of coherency in its general study. The same has contributed to the loss of blood, treasure, and the right living of people (e.g., unnecessary war-related deaths and expenditures, scandals that damage organizations, injustice, racism, and many others) across the world (Nance, 2021). The fall of Enron, companies over 80 years in tenure, the government of Afghanistan, aggression towards Ukraine, and inaction prior to COVID-19, are a few of the more serious implications of continuing the status quo concerning leadership and its failure. Billions of dollars are spent on management and leadership in America, of the tens of billions spent globally (Bersin, 2014; Feser et al., 2017; Freifeld, 2015; Pfeffer, 2015; Schwartz et al., 2016); however, leadership failures are many and expectations are low (Berndtson, 2020; Bolden, 2004; Milken Institute, 2020; Pfeffer, 2015). The said state is across time and continues with a low return on investment. Further, consider the estimated 24 trillion in lost revenues and 11 trillion associated with the pandemic's cost, according to the International Monetary Fund (IMF, 2020). Holding greater significance than monetary losses of the latest pandemic is the loss of life for millions of people (John Hopkins University, 2021).

Leadership confidence decreased, as spending and development increased (Funk & Kennedy, 2017; Milken Institute, 2020; Rosenthal, 2012; Stokes, 2017). The field is perceived in its current evidentiary state, wanting a general theory (Bryman et al., 2011; Burns, 1978, p. 3; Sorenson et al., 2011; University of Michigan, 2019). Though many facts and direction came from the Kellogg Leadership Studies Project (KLSP), a 4-year initiative with over 25 scholars across early stages, sponsored by the W. K. Kellogg Foundation; no consensus on a general theory developed from the work of the group (Sorenson et al., 2011). Peter Northouse, author of one of the most widely used leadership texts in universities stated, “I wish there were a single theory” (University of Michigan, 2019). Enough said a crisis existed throughout the past decades (Funk & Kennedy, 2017; Milken Institute, 2020; Nohria & Khurana, 2010; Rosenthal, 2012; Stokes, 2017). Scholars expressed disappointment with the state of research, popular approaches, lack of a general theory, diverged interests, mounting definitions, theoretical misalignment, and reductionism (Bryman et al., 2011; Burns, 1978, p. 3; Ko et al., 2017; Sorenson et al., 2011; University of Michigan, 2019). Early foundational leadership studies were flawed according to today's scientific methods (Carlyle, 1840; Galton, 1869). James MacGregor Burn said leadership is a moral undertaking (Burns, 1978). His contribution to the transformational leadership theory was enough to make it one of the best midrange theories, yet far from the latent variables addressed in this methods and model. The stated conditions in the world and the state of leadership as commonly understood create the demand for the subject method-model and formula for leadership's sustainability. The sustainable-unsustainable leadership theory (SULT), leadership's grand theory, underpins the method-model and formula.

### SUMMARY OF THE INVENTION

The SULT method-model for sustainable leadership development, premised on leadership's grand theory, which emerged from a 3-year exploratory sequential mixed methods study, provided scientific evidence supporting the method and formula contained herein. A theory emerged during theoretical sampling and constant comparative analysis of interviews from six continents, giving rise to the aphorism “leadership in the absence of moral action is unsustainable.” A longitudinal literature exploration across 3,000 years ensued after theory emergence, which supported qualitative findings of a classical grounded theory approach. Random sampling from 2,523 global cases, analyzing 2,191 cases in a quantitative phase, showed a statistically significant association between unethical leadership action (ULA) and unsustainable leadership outcomes (ULO), χ²(1, N=2,191)=119.643, p<0.001. There was a relatively strong association between ULA and ULO, ϕ=0.436, p<0.001 (Nance, 2021). Thus, indicating there is a relatively strong association between unethical or immoral leadership action and unsustainable leadership outcomes. Leadership does not function according to its definition and common expectations without a moral component interweaved into all elements or dimensions. In the absence of the moral component, the endeavor would manifest degradation and harm in the complex multiple-triadic relational practice and thus experience degradation, harm, and or failure.

Instead of a focus on a growing list of 101 or more skills and traits, sometimes described as must-haves, the sustainable-unsustainable leadership theory (SULT) puts forth a unique method and model for leadership development and practice. The emphasis on traits and skills was long-promulgated and utilized amidst periods of low trust, confidence, and the failure of leadership; the SULT focuses on the development of the conscience as part of its described multiple-triadic relational leadership model. The conscience is explicitly overlooked in leadership development. The morally developed (a) conscience interacts with (b) cognition and then helps to regulate (c) conduct of the practitioner. The sustainable-unsustainable leadership theory, development methods, and practice are consistent with its formula and definitions. Leadership according to SULT, is the function of (a) moral influence and or inspiration, (b) wisdom influence and or inspiration, (c) understanding influence and or inspiration, (d) knowledge influence and or inspiration, and (e) purpose influence and or inspiration. The same unique combination of dimensions facilitates numerous efficiencies compared to skill acquisition. The moral component of SULT underpins, influences, and inspires the right-use of every dimension of the leadership construct. The same gives it a priority in the phenomenon and theory, unlike too many other midrange and local theories, across paradigms since 1840 to date, which explicitly omits the crucial dimension. The leadership theories that include some form of a moral component are described as fragmented and lacking a strong theoretical underpinning (Bier & Sherblom, 2020; Ko et al., 2017; Newstead et al., 2019). SULT, leadership's grand theory is not another moral leadership theory, which suffers from the concerns generated by scholars, but leadership's grand theory, put forth with an essential moral common core—a necessity for effective leadership and its sustainability.

### BRIEF DESCRIPTION OF DRAWINGS

FIG. 1 illustrates the multiple-triadic relational model in leadership.

FIG. 2 illustrates the leadership construct from its unique formula, combinations of dimensions, relevance, interactions of the dimensions in the method-model, alignment with it formula, definitions, and underpinned by SULT.

### DETAILED DESCRIPTION OF THE INVENTION

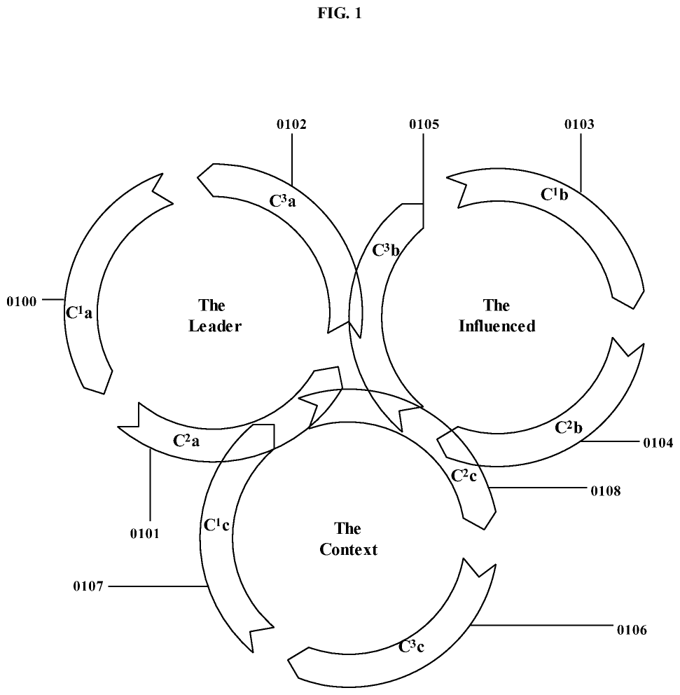

The method and model places emphasis on the conscience in the mostly latent multiple-triadic relational model in practice. Instead of focusing on a list of 101 or more skills and traits, the sustainable-unsustainable leadership theory (SULT) asserts a unique method and model for development and practice. SULT, as leadership's grand theory, with its mostly-high-level dimensions, as a method and or model is predictive, prescriptive, and preventative. Emphasis on traits and skills were long promulgated and utilized amidst decades of low trust, low confidence, and failure of leadership to date; the SULT focuses on the development of the conscience as part of the multiple-triadic relational practice of leadership. There is common view of leadership as positional, skills, and traits based. A less common psychological perspective looks closer at the constructs for behavior, attitude, disposition, and experiences. Below the surface of position, skills, traits, behavior, and experience is a critical latent set variables from a psychological perspective. The conscience is explicitly overlooked in leadership development. In a simplified depiction of the complex in the multiple-triadic relational model, the morally developed (a) conscience (C¹a) 0100 interacts with (b) cognition (C²a) 0101, and thus helps to regulate the (c) conduct (C³a) 0102 of the leader as a practitioner. Those influenced have similar interactions when influenced by a leader, as the (a) conscience (C¹b) 0103 interacts with (b) cognition (C²b) 0104, and thus helps to regulate (c) conduct (C³b) 0105 of the influenced. The influenced phraseology helps to account for those who are influenced by a leaders but have no direct contact as those called followers. An influenced individual may only subscribe to certain aspects of the leader. Cognitions of another can be known, but often enough seen in the conduct (C³a) 0102 of the leader and conduct (C³b) 0105 of the influenced. See FIG. 1.

The conscience, cognition, and conduct of the leader and the those influenced can be affected by context. See FIG. 1. The context consists of the culture (C¹c) 0106, the community (C²c) 0107, and the constructions (C³c) 0108 thereof. Culture has a bearing on how a community thinks and conducts itself, as consciences are lived out depending on the development of each constituent. A culture mainly consists of shared values, meanings, attitudes, and beliefs. The constructions that stem from each community, local or global, can be physical, such as an organization structure, neighborhood, town, city, state, or others. Other constructions could be ideological or social constructions such as race and have a considerable impact on the interaction of communities although not based on scientific evidence. Forms of government, certain behaviors, and standards of deviance are constructions that exist in a context. The method-model, formula, and definitions will intervene in the contexts and those influenced by the leader(s) right-influence and or inspiration.

The definitions raised by SULT, from the science, principles, and empirical evidence longitudinally, is unambiguous and instructive. To date, most definitions support what a community or scholars see and not necessarily the fact or latent variables of the art and or science of leadership. The same documented meanings make space for the degradation, harm, and failure resulting from purported leaders. Such allowance in definitions potentially reflects a society's usage and understanding of terms and thus, contributes to the state of the same. The prescriptive and instructive definition in the communication of meaning allows for the corrective capacity of the conscience to guide a practitioner back on course during potential veering by humans. The conveyed meaning makes clear the leadership practice while distinguishing it from conflated practices such as authoritarianism and totalitarianism. A practice of authoritarianism by a practitioner who may also be a head of state, but not a leader according to leadership's grand theory and the emerged definition. See Table 1 for leadership definitions.

TABLE 1
Leadership Definitions

| Term | Definitions | Usage |
|---|---|---|
| leader/′lēd [symbol] r/noun | a person who | (a) Kenneth-Maxwell |
| | practices | was not only a |
| | leadership. | president, but also |
| | | a leader. |
| | | (b) a head of state |
| | | is not a leader when |
| | | there is the practice |
| | | of authoritarianism. |
| leadership/′lēd [symbol] r, SHip/ | a complex multiple- | Leadership is necessary |
| noun (no plural) | triadic relational | to make progress on |
| | practice of right- | sustainable development |
| | influence and | goals. |
| | or right-inspiration | |
| | toward purposes and | |
| | transcendence. | |

Note:
The definitions are grounded in leadership's grand theory and research (Nance, in press). The same is applicable to any context (e.g., government, private/public organizations, military, others).

Purposes as part of the definition encompasses objectives, goals, visions, reasons, and similar. Transcendence in the definition, relates the capacity and desired trajectory of humans. Due to agape moral virtue the same can facilitate the process, when it was said that leaders and those influenced were to raise the other “to higher levels of morality” as perceived by the James MacGregor Burns, now supported by the science (Burns, 1978; Nance, in press).

When instruction or training is formalized, there is the emphasis on the development of the conscience with instruction guided by the moral influence and inspiration dimension, interactive with four other dimensions which further comprise SULT. A related assessment would focus on a subdimensions-based walk-talk alignment instrument.

The sustainable-unsustainable leadership theory and development method, align with its formula and definitions. The formula for the leadership construct is L=f(Mii, Wii, Uii, Kii, Pii). Leadership according to SULT, is the function of (a) moral influence and or inspiration, (b) wisdom influence and or inspiration, (c) understanding influence and or inspiration, (d) knowledge influence and or inspiration, and (e) purpose influence and or inspiration. The same unique combination of dimensions facilitates numerous efficiencies compared to skill acquisition.

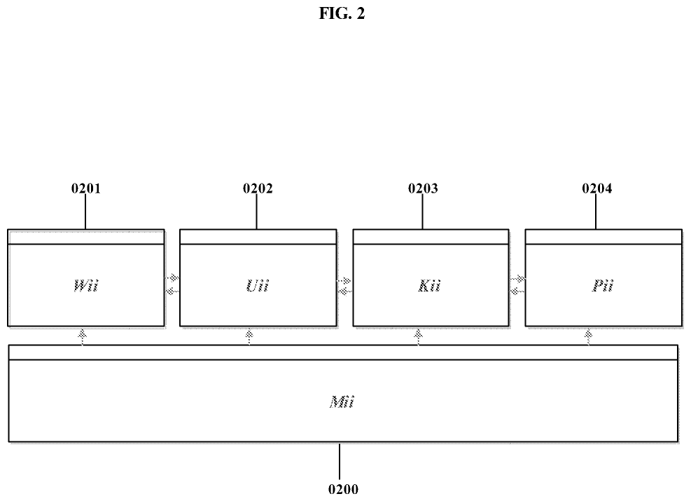

The moral dimension (Mii) 0200 of SULT underpins, influences, and provides inspiration to facilitate the right-use of the multi-dimensional leadership construct, which includes wisdom influence and or inspiration (Wii) 0201, understanding influence and or inspiration (Uii) 0202, knowledge influence and or inspiration (Kii) 0203, and purpose influence and or inspiration (Pii) 0204. See FIG. 2. The method and model give moral influence and or inspiration priority in the phenomenon and theory, unlike most midrange and local theories across all paradigms since the year 1840. Scholars and others assert that leadership is influence, but there are good and bad influences. Bad influence degrades and causes harm to the leadership relationship based on science. There is also social influence, a related phenomenon that could promote an inconsistent polarity in a practice. Right-influence and or inspiration are throughout the construct to help prevent degradation, harm, and failure (e.g., the right use of knowledge). All the dimensions of the construct can induce influence and or inspiration. However, understanding the wrong use of knowledge has contributed to the downfall of many organizations. The failure of one of the world's top accounting firms is one clear example of what can occur among even the most talented and experienced that veer away from a moral premise.

The foundational dimension of the leadership construct is its moral influence and or inspiration component. It is one of the five dimensions, comprising the leadership construct. The moral dimension is underpinned by agape moral virtue (AMV) (American Psychological Association, n.d.; Lake, 1911; Nance, 2022). American Psychological Association (2020) defined agape as the highest form of love that is complex, altruistic, with self-denial which has an attitudinal and behavioral construct of social interest. Agape a term derived from the Greek language has the capacity to facilitate the reaffirmed values of the United Nations General Assembly with its 15 subdimensions (Lake, 1911; United Nations General Assembly, 2005). There is sometimes the question of whose morality. Agape and or its principles are universal as it relates to the needs of humans (Maslow, 1943, 1962). The practical subdimensions are applied to applications of all dimensions of the leadership construct. Thus, within the instruction related to other dimensions, the Mii dimension contextualizes and guides application any instruction related to another dimension. The subdimensions are consistently applied in the multiple-triadic relationship where appropriate. See Table 2.

TABLE 2
Leadership Construct Moral Dimension:
Agape Moral Virtue Subdimensions

| Agape | | Abbreviation/ |
|---|---|---|
| subdimensions | Description | Acrostic |
| 1 | Long suffering (patience) | LS |
| 2 | Kind | K |
| 3 | Not envious | En- |
| 4 | Not boastful | Bo- |
| 5 | Not prideful | PU- |
| 6 | Not rude | BehR- |
| 7 | Not self-seeking (seeks the benefit of | SS- |
| | others) | |
| 8 | Not easily provoked | EaP- |
| 9 | Thinks no evil | TE- |
| 10 | Not rejoiceful in iniquity (wrongdoing) | RI- |
| 11 | Rejoices in truth | RT |
| 12 | Bears all things (tolerant) | BA |
| 13 | Believes all things | BelA |
| 14 | Hope all things | HA |
| 15 | Endures all things (endurance) | EnA |

Notes:
Adapted from Lake (1911).

All the subdimensions interact and work primarily through the conscience and influences/inspires the mostly cognitive aspect (e.g., wisdom, understanding, and knowledge), which appears most evident in the conduct of a practitioner. According to empirical and scientific evidence, a construct, or any context of leadership without a moral component, experiences degradation and harm in the direction of its failure.

Wisdom influence and or inspiration (0201) relates to insightful and right use of the right knowledge. One can apply wisdom used in a context with success. However, the understanding-influence and or inspiration dimension helps one in the realization of the appropriateness and variation in or out of a context. Thus, understanding is an element to pursue alongside wisdom. The same applies to the other dimensions of the construct; largely underpinned by principles. The leader in various contexts will need to understand what is right, justice, equity, and good ways, while understanding how these satisfy human needs. See FIG. 2.

Understanding influence and or inspiration (0202) as another dimension, is a necessary component for sustainable leadership. Some people lack understanding about others and sometimes the essence of the knowledge used in a context. Understanding itself can be seen as an attribute, quality, attitude, or disposition held by one who practices leadership. Some may refer to it as comprehension or discernment. Understanding can be demonstrated beyond an affirmation, with sympathetic awareness of others on various levels. Psychology aims to understand the mind and human behavior. See FIG. 2.

The knowledge influence and or inspiration dimension (0203) is largely the aspect that is different wherever a leadership context exists, mainly due to the varying types and degrees of knowledge utilized in the space, such as priori, posteriori, encoded, tacit, domain knowledge, and others. In an organization, there are likely certain types and varying degrees of procedural knowledge or declarative knowledge associated with a field, discipline, or profession (e.g., sustainability, law enforcement, military, and others). The knowledge dimension is present in every form of leadership, particularly knowledge of those influenced and or inspired in the context of the multiple-triadic relational practice. The types and degrees of each vary. According to a common understanding of leadership across past paradigms, this dimension is a contributing factor to the proliferation of the various streams and skills observed; thus, the same became part of the skills and traits associated with leadership, although the general core of sustainable leadership should remain. The same is a factor in its definitions in the literature. Understanding the knowledge dimension of the construct will help in the understanding that leadership is leadership in any context, thus helping to keep the leadership construct intact irrespective of the types of right knowledge utilized and the contexts in which there is a practice. See FIG. 2.

The purpose influence and or inspiration dimension (0204), establishes the reason for the practitioner and the need for leadership in the context. The purpose dimension is associated with both internal and external purposes. The purpose includes and is often subject to aspects of the context in the multiple-triadic relational practice. A vision of an organization could provide support for its purpose(s). Not every purpose is a right or a good one, nor is every vision. If a purpose or vision is not right, the same is unsustainable. Consider the visions resulting in World War I and World War II. The reason, intention, and or objective must remain aligned with the moral dimension, its framing, or experience degradation, harm, and or failure. The purpose dimension encompasses the lives of people and the fulfillment of human needs (e.g., belonging, security, justice, transcendence, higher purposes, and fulfillment of one's life purpose). A purpose relates to the reason why. See FIG. 2.

The sustainable-unsustainable leadership theory goes further in the utilization of its moral component or dimension; the same made universal across more than 193 nations around the world. It provides a framework for the four other high-level global dimensions of the leadership construct. The dimensions and subdimensions interact across the multiple-triadic relational space of the practice and underpins the sustainable-unsustainable leadership theory. The conscience explicitly overlooked in leadership development and in the largest organization in the world, with the largest budget to develop leaders. Rules and threat of punishment are not substitutes for developing the conscience further; the same are at the ground level of development (Kohlberg, 1971). The morally developed (a) conscience interacts with (b) cognition and then helps to regulate (c) conduct of the practitioner. Character development is not enough. Examine the range of definitions in dictionaries, reflective of the range of understanding. Everyone has some form of character when it relates to a disposition, mental state, temperament, or attitude. There is sometimes a moral connotation.

The sustainable-unsustainable leadership theory, development methods, and practice are consistent with its formula and definitions. Leadership according to SULT, is the function of (a) moral influence and or inspiration, (b) wisdom influence and or inspiration, (c) understanding influence and or inspiration, (d) knowledge influence and or inspiration, and (e) purpose influence and or inspiration. The same unique combination of dimensions facilitates numerous efficiencies compared to skill acquisition. The moral component of SULT underpins, influences, and inspires the right use of every necessary dimension of the leadership construct for a sustainable leadership—one that does degrade, harm, and fail because of the leadership practice. The emphasis in the knowledge dimension (e.g., tacit, coded, others) could vary, depending on the context. This dimension is largely addressed by development in the context. Knowledge of self and those influenced with interaction of the developed conscience is fundamental to the dimension and teachable in any development context. Herein is recognition of a basis of what is seen as the inside threat—inside the inside threat which looks at individuals. A development program premised on the method-model, definitions, and formula is sustainable. The program would sustain, enhance, and facilitate transcendence while positively influencing the performance and practice of the practitioner and those influenced and or inspired. The key is application of the particulars of the Mii dimension to every element of the multi-triadic relational model, the dimensional method-model, while holding to the prescriptive and instructive definitions and behavioral formula.

1. The sustainable-unsustainable leadership theory method-model for sustainable leadership development, comprising:
a multiple-triadic relational model,
a set of prescriptive and instructive definitions,
a social science behavioral formula, and
a five-dimensional method-model.

2. The sustainable-unsustainable leadership theory method-model for sustainable leadership development, the multiple-triadic relational model of claim 1, further comprising:
a leader construct,
an influenced construct, and
a context construct.

3. The sustainable-unsustainable leadership theory method-model for sustainable leadership development, the multiple-triadic relational model, the leader construct of claim 2, further comprising:
a conscience (C¹a) element,
a cognitive (C²a) element, and
a conduct (C³a) element.

4. The sustainable-unsustainable leadership theory method-model for sustainable leadership development, the multiple-triadic relational model, the influenced construct of claim 2, further comprising:
a conscience (C¹b) element,
a cognitive (C²b) element, and
a conduct (C³b) element.

5. The sustainable-unsustainable leadership theory method-model for sustainable leadership development, the multiple-triadic relational model, the context construct of claim 2, further comprising:
a culture (C¹c) element,
a community (C²c) element, and
a constructions (C³c) element.

6. The sustainable-unsustainable leadership theory method-model for sustainable leadership development, the prescriptive and instructive definitions of claim 1, further comprising:
a prescriptive and instructive definition for a leader premised on theory, and
a prescriptive and instructive definition for a leadership premised on theory.

7. The sustainable-unsustainable leadership theory method-model for sustainable leadership development, the behavioral formula of claim 1, further comprising:
an Mii element,
a Wii element,
a Uii element,
a Kii element, and
a Pii element.

8. The sustainable-unsustainable leadership theory method-model for sustainable leadership development, the five-dimensional method-model of claim 1, further comprising:
a moral influence and or inspiration (Mii) dimension,
a wisdom influence and or inspiration (Wii) dimension,
an understanding influence and or inspiration (Uii) dimension,
a knowledge influence and or inspiration (Kii) dimension, and
a purpose influence and or inspiration (Pii) dimension.

9. The sustainable-unsustainable leadership theory method-model for sustainable leadership development, the five-dimensional method-model, the moral influence and or inspiration dimension of claim 8, further comprising:
a long suffering (LS) subdimension,
a kind (K) subdimension,
a not envious (En-) subdimension,
a not boastful (Bo-) subdimension,
a not prideful (PU-) subdimension,
a not rude (BehR-) subdimension,
a not self-seeking (SS-) subdimension,
a not easily provoked (EaP-) subdimension,
a thinks no evil (TE-) subdimension,
a not rejoiceful in iniquity (RI-) subdimension,
a rejoices in truth (RT) subdimension,
a bears all things (BA) subdimension,
a believes all things (BelA) subdimension,
a hopes all things (HA) subdimension, and
an endures all things (EnA) subdimension.
